(19) United States
(12) Patent Application Publication
(10) Pub. No.: US 2026/0051427 A1
(43) Pub. Date: Feb. 19, 2026

(54) NON-ORIENTED ELECTRICAL STEEL FOR ELECTRIC VEHICLE DRIVE MOTOR AND MANUFACTURING METHOD THEREOF

(71) Applicant: Baoshan Iron & Steel Co., Ltd., Shanghai (CN)

(72) Inventors: Xianshi Fang, Shanghai (CN); Feng Zhang, Shanghai (CN); Bo Wang, Shanghai (CN); Yunwei Hao, Shanghai (CN); Lin Zhou, Shanghai (CN)

(21) Appl. No.: 19/103,223

(22) PCT Filed: Aug. 14, 2023
(86) PCT No.: PCT/CN2023/112938

§ 371 Date: Feb. 11, 2025

(30) Foreign Application Priority Data
Aug. 15, 2022 (CN) 202210977542.9

(51) Int. Cl. H01F 1/147; C21D 1/28; C21D 6/00; C21D 8/12; C21D 9/46; C22C 38/00; C22C 38/02; C22C 38/04; C22C 38/06; C22C 38/10; C22C 38/16; C22C 38/30; C22C 38/32; C22C 38/38; C22C 38/42; C22C 38/52; C22C 38/54; C22C 38/58; C22C 38/60

(52) U.S. Cl. CPC H01F 1/14783; C21D 1/28; C21D 6/001; C21D 6/002; C21D 6/004; C21D 6/005; C21D 6/007; C21D 6/008; C21D 8/1222; C21D 8/1233; C21D 8/1261; C21D 8/1266; C21D 8/1283; C21D 9/46; C22C 38/001; C22C 38/002; C22C 38/004; C22C 38/008; C22C 38/02; C22C 38/04; C22C 38/06; C22C 38/105; C22C 38/16; C22C 38/30; C22C 38/32; C22C 38/38; C22C 38/42; C22C 38/52; C22C 38/54; C22C 38/58; C22C 38/60; C22C 2202/02

(57) ABSTRACT

The present invention discloses a non-oriented electrical steel for electric vehicle drive motors, comprising, in addition to Fe and inevitable impurities, the following chemical elements in percentage by mass: C≤0.003%, Si: 3.0-4.5%, Al: 0.15-2.5%, Mn: 0.15-2.5%; the non-oriented electrical steel for an electric vehicle drive motor has a magnetic induction intensity B_{50M} of ≥1.60T, wherein B_{50M}=(B_{50L}+B_{50C}+2B_{50X})/4, wherein B_{50L} is a magnetic induction intensity in a rolling direction of the non-oriented electrical steel when magnetized under a magnetic field of 5000 A/m, B_{50C} is a magnetic induction intensity perpendicular to the rolling direction of the non-oriented electrical steel when magnetized under a magnetic field of 5000 A/m, B_{50X} is a minimum value of magnetic induction intensity of the non-oriented electrical steel at different angles to the rolling direction when magnetized under a magnetic field of 5000 A/m. The present invention further discloses a method for manufacturing the non-oriented electrical steel.

### TECHNICAL FIELD

The present invention relates to a steel and a manufacturing method thereof, in particular to a non-oriented electrical steel and a manufacturing method thereof.

### BACKGROUND

In recent years, with the increasing attention paid by countries around the world to carbon emission reduction, environmental protection and energy conservation, traditional fuel vehicles are gradually being replaced by electric vehicles, the market and users' demand for electric vehicles is also increasing, and more and more automobile enterprises are beginning to invest in the research and development as well as manufacturing of electric vehicles.

Currently, in order to obtain more competitive electric vehicles, many automobile-manufacturing enterprises are constantly increasing their requirements for the drive motors of electric vehicles. They require that the drive motors have the characteristics of miniaturization, high power density, high rotational speed, etc., and at the same time, the operating frequency range also reaches 400 Hz to several thousand Hz.

In order to meet these requirements for the drive motor, the non-oriented silicon steel used as the motor core material needs to have the characteristics of high frequency and low iron loss to meet the high-efficiency conversion of energy: in addition, the non-oriented silicon steel used as the motor core material needs to have sufficiently high strength to ensure that the motor rotor does not deform or break during high-speed rotation: moreover, the non-oriented silicon steel also needs to have excellent magnetic induction intensity to meet the requirement of high torque when the motor starts or accelerates, wherein in addition to requiring excellent magnetic induction intensity in longitudinal direction (rolling direction) and transverse direction (perpendicular to the rolling direction), the magnetic performance in other directions, especially the magnetic performance in the direction of the minimum magnetic value, also has an important influence on the motor performance. That is to say, it is desired that the magnetic induction intensity in the direction of the minimum magnetic value is also very excellent.

In response to this demand, some researchers have currently conducted a lot of research and achieved certain results, but the practical application effects are not ideal:

For example, the Chinese patent document with publication number of CN106435358 A and publication date of Feb. 22, 2017, and entitled “A method for manufacturing high-strength non-oriented silicon steel for a new energy vehicle drive motor”, discloses a high-strength non-oriented silicon steel for a new energy vehicle drive motor, and a non-oriented silicon steel with a yield strength of 600-780 MPa can be obtained through NbC precipitation and fine grain structure strengthening by using a thin-strip continuous casting process and a low-temperature annealing process. However, in the non-oriented silicon steel plate obtained in this technical solution, the high-frequency iron loss is relatively high, the P_{10/400} at 400 Hz has reached 28.0-38.2 W/kg, and the iron loss will further increase at 600 Hz; and at the same time, there is no report on the control of magnetic anisotropy.

For another example, the Chinese patent document with publication number of CN111471941 A and publication date of Jul. 31, 2020, and entitled “A high-strength non-oriented silicon steel with a yield strength of 600 MPa grade for a new energy vehicle drive motor rotor and a manufacturing method thereof”, discloses a high-strength non-oriented silicon steel, the chemical composition of which is (by wt %): Si: 2.8%-3.5%, Mn: 0.35%-0.65%, Als: 0.50%-0.80%: solid solution strengthening is performed by adding any two elements selected from Cr, Nb, Ti, Ni and V, and the content range thereof is 0.05%-0.55%. This technical solution obtains a product with a yield strength of more than 600 MPa by enhancing the {111} surface texture, but the iron loss P_{10/400} of the product is as high as 22.6-30.4 W/kg, and the loss will be higher if at a higher frequency of 600 Hz.

On this basis, being different from the above-mentioned existing technical solutions, the inventors design and expect to obtain a new non-oriented electrical steel for an electric vehicle drive motor and a manufacturing method thereof to meet the needs of the market and users.

### SUMMARY

One of the objects of the present invention is to provide a non-oriented electrical steel for an electric vehicle drive motor. The non-oriented electrical steel has the characteristics of high strength, low iron loss at high frequency, high magnetic induction intensity and small magnetic anisotropy, and has good promotion prospects and application value. The non-oriented electrical steel can be used to effectively prepare the drive motors of new energy vehicles, and can effectively meet the market's requirements in terms of high rotational speed, miniaturization, high torque, etc., of electric vehicle drive motors.

In order to achieve the above object, the present invention provides a non-oriented electrical steel for an electric vehicle drive motor, and the non-oriented electrical steel plate comprises, in addition to Fe and inevitable impurities, the following chemical elements in percentage by mass:
C≤0.003%, Si: 3.0-4.5%, Al: 0.15-2.5%, Mn: 0.15-2.5%;
the non-oriented electrical steel has a magnetic induction intensity B_{50M} of ≥1.60 T, wherein B_{50M}=(B_{50L}+B_{50C}+2B_{50X})/4, wherein, B_{50L} is a magnetic induction intensity in a rolling direction of the non-oriented electrical steel when magnetized under a magnetic field of 5000 A/m, B_{50C} is a magnetic induction intensity perpendicular to the rolling direction of the non-oriented electrical steel when magnetized under a magnetic field of 5000 A/m, B_{50X} is a minimum value of magnetic induction intensity of the non-oriented electrical steel at different angles from the rolling direction when magnetized under a magnetic field of 5000 A/m.

Preferably, in the non-oriented electrical steel for an electric vehicle drive motor according to the present invention, the chemical elements in percentage by mass are:

C≤0.003%, Si: 3.0-4.5%, Al: 0.15-2.5%, Mn: 0.15-2.5%; the balance being Fe and inevitable impurities.

In the non-oriented electrical steel for an electric vehicle drive motor according to the present invention, the design principles of each chemical element are as follows:

C: C element is an impurity element, which is harmful to the magnetic performance of non-oriented silicon steel. Therefore, the C element content must be strictly controlled to 0.003% or less, that is, the C element content in the steel is controlled to satisfy: C≤0.003%.

In some embodiments, in order to obtain a better implementation effect, the C element content in percentage by mass is preferably controlled to: C≤0.002%.

Si: The addition of an appropriate amount of Si element to the steel can increase the resistivity and reduce the iron loss of the non-oriented electrical steel plate: at the same time, Si, as a solid solution strengthening element, can also improve the strength of the steel plate. Therefore, in order to exert the beneficial effects of the Si element and enable the steel to obtain the performances of high yield strength, low iron loss at high frequency, the Si element content in the steel needs to be 3.0% or more. However, it should be noted that the Si element content in the steel should not be too high. When the Si element content in the steel exceeds 4.5%, an ordered phase Fe₃Si or FeSi will appear, the room temperature plasticity of the material will deteriorate sharply, and the industrial large-scale cold rolling production cannot be carried out, and the magnetic induction intensity will also deteriorate. On this basis, considering the influence of Si element content on steel performances, the Si element content in percentage by mass is controlled to 3.0-4.5%, specifically, for example, to 3.3-4.2%, to 3.5-4.0%, or to 3.8%, in the non-oriented electrical steel for an electric vehicle drive motor according to the present invention.

Al: Al is also an effective element for increasing resistivity and reducing iron loss. Considering the effect of this element on improving iron loss, Al of 0.15% or more needs to be added to the steel. However, the Al element content in the steel should not be too high. Adding excessive Al will be detrimental to the magnetic induction intensity of the steel, causing difficulties in steelmaking and casting, and leading to deterioration of the cold workability of the steel plate. Therefore, the amount of Al added to the steel should not exceed 2.5%. On this basis, the Al element content in percentage by mass is controlled to 0.15-2.5%, specifically, for example, to 0.2-2.0%, to 0.5-1.8%, to 0.8-1.5%, or to 1.0-1.2%, in the non-oriented electrical steel for the electric vehicle drive motor according to the present invention.

Mn: Mn element can increase the resistivity of the steel. At the same time, the Mn element can also react with S element to form MnS, thereby improving the electromagnetic performance of the steel. Therefore, in order to exert the beneficial effects of Mn element, it is necessary to add Mn of 0.15% or more to the steel. However, it should be noted that the Mn element content in the steel should not be too high. When the Mn element content in the steel exceeds 2.5%, it will lead to the reduction in plasticity of the steel and result in strip breakage during cold rolling. On this basis, in order to exert the beneficial effects of Mn element, the Mn element content in percentage by mass is controlled to 0.15-2.5%, specifically, for example, to 0.2-2.0%, to 0.5-1.8%, to 0.8-1.5%, or to 1.0-1.2%, in the non-oriented electrical steel for the electric vehicle drive motor described in the present invention.

The non-oriented electrical steel for an electric vehicle drive motor designed by the present invention not only has high strength, low iron loss at high frequency, and high magnetic induction intensity, but also has the characteristic of small magnetic anisotropy. It has a yield strength of ≥440 MPa, an iron loss P_{10/600} of ≤30 W/kg, and a magnetic induction intensity B_{50M} of ≥1.60 T.

Regarding the iron loss, since the new energy electric vehicle drive motor is constantly developing towards miniaturization and high efficiency, it requires that the iron loss of the non-oriented electrical steel at high frequency is as small as possible. The non-oriented electrical steel according to the present invention has a low iron loss, and its iron loss P_{10/600} is ≤30 W/kg under the condition of a magnetic flux density of 1.0 T and a frequency of 600 Hz.

Regarding yield strength, the rotor of the drive motor for electric vehicles should have high reliability under high-speed operation. In particular, when the rotational speed exceeds 15,000 rpm, the core material needs to have a sufficiently high strength to ensure that the material does not deform or break. The non-oriented electrical steel according to the present invention has a high yield strength, and its yield strength is ≥440 MPa.

Regarding magnetic induction intensity, during the operation of the electric vehicle drive motor, the excitation direction of the steel plate is constantly changing. In the motor design, for the non-oriented electrical steel used, in addition to the requirement of excellent magnetic induction intensity in the longitudinal direction (rolling direction) and transverse direction (perpendicular to the rolling direction), the magnetic performance in other directions, especially the magnetic induction intensity in the direction of the minimum magnetic performance value, also has an important influence on the performance of the motor.

The magnetic induction intensity B_{50M} of the non-oriented electrical steel according to the present invention is ≥1.60 T, and satisfies B_{50M}=(B_{50L}+B_{50C}+2B_{50X})/4, thereby satisfying the above requirements of the electric vehicle drive motor for magnetic induction intensity and obtaining non-oriented electrical steel with small magnetic anisotropy.

Preferably, in the non-oriented electrical steel for an electric vehicle drive motor described in the present invention, C≤0.002%.

Preferably, in the non-oriented electrical steel for an electric vehicle drive motor described in the present invention, among the inevitable impurities, P≤0.03%, S≤0.003%, N≤0.005%, O≤0.0030%.

In the non-oriented electrical steel for an electric vehicle drive motor described in the present invention, elements P, S, N and O are all impurity elements in the non-oriented electrical steel plate. Where the technical condition permits, in order to obtain a steel with better performance and better quality, the content of impurity elements in the steel should be reduced as much as possible.

P: In the present invention, P is a grain boundary segregation element. For a composition system with Si≥3.0%, if the content of impurity element P in the steel exceeds 0.03%, the brittleness of the electrical steel plate will be aggravated and the electrical steel plate will be difficult to be rolled. Therefore, in the non-oriented electrical steel for an electric vehicle drive motor described in the present invention, the P element content in percentage by mass is controlled to: P≤0.03%. In some preferred embodiments, it can be further controlled to: P≤0.02%, or P≤0.01% or P≤0.005%.

S: In the present invention, S is an element harmful to magnetic performance. The S element will combine with Mn to form fine MnS, thereby hindering the growth of grains during the finish annealing and deteriorating the magnetic performance of the steel plate. Therefore, in the non-oriented electrical steel for an electric vehicle drive motor described in the present invention, the S element content in percentage by mass is controlled to: S≤0.003%.

N: In the present invention, N is an element harmful to magnetic performance. The N element will form fine nitrides with elements such as Al, Ti, Nb, and V, hindering grain growth. Therefore, in the non-oriented electrical steel for an electric vehicle drive motor described in the present invention, the N element content in percentage by mass is controlled to: N≤0.005%. In some preferred embodiments, it can be further controlled to: N≤0.0035%.

O: In the present invention, O is a harmful element. For a composition system with Si≥3.0%, the cold workability of the material is very sensitive to the segregation of oxygen at the grain boundary. At the same time, the oxides of silicon, aluminum, manganese, etc. formed will also deteriorate the magnetic performance of the material. Therefore, in the non-oriented electrical steel for an electric vehicle drive motor described in the present invention, the O element content in percentage by mass is controlled to be: O≤0.0030%.

Preferably, in the non-oriented electrical steel for an electric vehicle drive motor described in the present invention, among the inevitable impurities, P≤0.02%, N≤0.0035%.

Preferably, the non-oriented electrical steel for an electric vehicle drive motor described in the present invention further comprises B in percentage by mass of 0.0005%-0.010%.

In the present invention, in order to further optimize the performance of the designed non-oriented electrical steel for electric vehicle drive motors, preferably an appropriate amount of B element can further be added to the steel.

B: B is a grain boundary strengthening element, which can enhance the grain boundary bonding ability of the high-silicon composition system, thereby improving the cold rolling processing performance of materials. However, it should be noted that an appropriate amount of B needs to be added to the steel. When the B element is added in excess, it will refine the grain structure and is not conducive to the magnetic performance. Therefore, the B element content may not exceed 0.010%; and when the B element content in the steel is less than 0.0005%, it will not have the effect of grain boundary strengthening. Therefore, in the non-oriented electrical steel for an electric vehicle drive motor described in the present invention, it is preferred to add 0.0005%-0.010% of B element.

Preferably, the non-oriented electrical steel for an electric vehicle drive motor described in the present invention further comprises at least one selected from Co, Ni, Sn, Sb, Cu, and Cr in a total amount of 0.020-4.0% by mass.

In the present invention, Co, Ni, Sn, Sb, Cu, Cr or a combination thereof is preferably added further to the non-oriented electrical steel for an electric vehicle drive motor.

Wherein, Sn and Sb are both grain boundary segregation elements: On one hand, Sn and Sb can hinder the diffusion of trace oxygen along the grain boundary during the normalizing annealing process of a hot-rolled plate, prevent oxidation and plasticity deterioration in the steel plate, and on the other hand, Sn and Sb can improve textures beneficial to magnetic performance such as {100} surface texture and Goss texture during the finish annealing process. Elements such as Co, Ni, Cu, and Cr can play a role in solid solution strengthening, and can also increase the resistivity of a material and improve the iron loss performance of a steel.

In order to exert the beneficial effects of the above elements, in the present invention, it is preferred to add at least one selected from Co, Ni, Sn, Sb, Cu, and Cr, and the total percentage by mass of these elements is controlled to be 0.020% or more. When the total percentage by mass of these elements exceeds 4.0%, the improvement effect provided by these elements tends to be saturated, increasing the manufacturing cost. Therefore, the total percentage by mass of these elements may not exceed 4.0%.

Preferably, the non-oriented electrical steel for an electric vehicle drive motor described in the present invention has a thickness of 0.1-0.3 mm. This is because: the eddy current loss in iron loss at high frequency can be effectively reduced by reducing the thickness, therefore, the thickness of the finished steel plate is preferably 0.30 mm or less: in addition, from the perspective of the production efficiency of drive motor, when the steel plate used is too thin, the production efficiency will be reduced, therefore it is preferred to control the thickness of the finished steel plate to 0.10 mm or more.

Preferably, the non-oriented electrical steel for an electric vehicle drive motor described in the present invention has a yield strength of ≥440 MPa, and an iron loss P_{10/600} of ≤30 W/kg.

Another object of the present invention is to provide a method for manufacturing the above-mentioned non-oriented electrical steel for electric vehicle drive motors. The method is simple and feasible, and a non-oriented electrical steel plate with excellent mechanical and electromagnetic performances can be obtained by the method.

In order to achieve the above-mentioned invention object, the present invention provides a method for manufacturing a non-oriented electrical steel for electric vehicle drive motors, comprising the following steps:
(1) preparing a casting slab;
(2) hot rolling the casting slab to obtain a hot-rolled plate with a thickness of 1.5 to 2.2 mm;
(3) normalizing annealing the hot-rolled plate at a normalizing annealing temperature of 820° C. to 950° C.;
(4) cold rolling to obtain a cold-rolled plate;
(5) continuous annealing the cold-rolled plate in a continuous annealing furnace;
(6) applying an insulating coating.

In the present invention, the inventors optimize the chemical composition design of the steel and defines a reasonable manufacturing process. After a continuous casted slab is prepared according to the designed chemical composition, the continuous casted slab needs to be sequentially subjected to the process steps of hot rolling, normalizing annealing, cold rolling (for example, it can be a single cold rolling or a double cold rolling including intermediate annealing), final continuous annealing and coating an insulating coating, being able to effectively prepare the non-oriented electrical steel for an electric vehicle drive motor with excellent comprehensive performance designed by the present invention, which can be used to effectively manufacture electric vehicle drive motors, and has the characteristics of high strength, low iron loss at high frequency, high magnetic induction intensity, and small magnetic anisotropy.

In the above hot rolling process of step (2) according to the present invention, the thickness of the hot-rolled plate obtained by hot rolling needs to be controlled between 1.5 mm and 2.2 mm to obtain a thin gauge hot-rolled plate. This is because: the texture components of the cold-rolled plate can be improved and the intensity of the unfavorable texture (y fiber texture) can be reduced by reducing the thickness of the hot-rolled plate and reducing the cold rolling reduction ratio. However, it should be noted that the hot-rolled plate cannot be too thin, otherwise it will lead to increased production difficulties and poor plate shape, which is not conducive to the control of the thickness fluctuation on one plate. Therefore, the thickness of the hot-rolled plate needs to be controlled to be 1.5 mm or more.

Accordingly, in the above normalizing annealing process of step (3) according to the present invention, the hot-rolled plate can be transported to a horizontal continuous annealing furnace for normalizing annealing, and the normalizing annealing temperature is strictly controlled between 820° C. and 950° C. The magnetic induction intensity of the finished product can be improved by the normalizing processing. However, the temperature cannot be too low, otherwise the effect of improving the magnetic induction intensity cannot be achieved. Therefore, the normalizing annealing temperature is controlled to 820° C. or more in the present invention. In addition, from the perspective of workability, for a high-silicon composition system, especially a normalized plate with a Si+Al content exceeding 4.5%, the grain size of the steel plate is too large, so that the strip is easily broken during cold rolling, resulting in production difficulties. Therefore, in the present invention, the normalizing annealing temperature is controlled to be not more than 950° C. preferably the holding time can be controlled to not more than 3 minutes.

Preferably, in step (3) in the manufacturing method described in the present invention, the unit tension F of a strip steel in an annealing furnace used for normalizing annealing is controlled to satisfy the relational expression (2): 1.5≤F≤(3.8+0.3 d)/([Si]²×T), wherein d is a thickness of the hot-rolled plate in mm, T is a normalizing annealing temperature in ° C., [Si] is a percentage by mass of silicon element in the hot-rolled plate, and F is in N/mm².

The above “[Si] is a percentage by mass of silicon element in the hot-rolled plate” means that when the [Si] content is, for example, 3.0%, 3.0% is substituted into the relational expression (2). In the present invention, controlling a small tension in the annealing furnace can promote the uniform recrystallization nucleation and growth of grains in various orientations of the strip steel during annealing to improve the magnetic performances in other directions and reduce the magnetic anisotropy, thereby obtaining a high magnetic induction intensity B_{50M}.

The present invention controls the normalizing annealing temperature to be 820° C.-950° C. and makes the unit tension F in an annealing furnace satisfy the relational expression (2), thereby being able to control the grain structure of the non-oriented electrical steel on the basis of the conventional continuous annealing process, make the average grain size D to 20-105 μm and make the average grain size D and the grain size distribution standard deviation S satisfy the following relational expression (1):

$$0.78 \leq S / D < 1. . \qquad ( 1 )$$

If the average grain size D and the relationship between the average grain size D and the grain size distribution standard deviation S in a non-oriented electrical steel do not satisfy the above conditions, the iron loss and yield strength of the non-oriented electrical steel will be deteriorated and the distribution of grain structure is unreasonable, which will lead to increased magnetic anisotropy and reduced magnetic induction B_{50M}, and the non-oriented electrical steel with small magnetic anisotropy cannot be obtained. If the average grain size of a non-oriented electrical steel is less than 20 μm, although the yield strength will increase, the iron loss P_{10/600} will deteriorate and may be higher than 30 W/kg: if the average grain size of a non-oriented electrical steel is greater than 105 μm, the yield strength will decrease. Alternatively, S/D can also be 0.80˜0.90, or 0.82˜0.87.

In the present invention, the setting range of the value of the unit tension F of a strip steel in an annealing furnace is related to the silicon content [Si] in the steel, the normalizing annealing temperature T, and the hot-rolled plate thickness d: wherein, the higher the Si element content [Si] in the steel, the higher the normalizing annealing temperature T, and the thinner the hot-rolled plate thickness d, the smaller the upper limit of the value of the unit tension F of a strip steel in an annealing furnace. This is because: the higher the Si element content [Si] in the steel, especially when exceeding 3.5%, the risk of brittle strip breakage of the strip steel increases significantly; and the higher the normalizing annealing temperature T and the thinner the hot-rolled plate thickness d, the steel is prone to deformation at high temperature section.

However, it should be noted that in the technical solution designed by the present invention, the value of the unit tension F of a strip steel in an annealing furnace cannot be too low, otherwise the strip steel will deviate and be scratched. Therefore, in the present invention, the value of the unit tension F of a strip steel in an annealing furnace is controlled to be 1.5 N/mm² or more.

Compared with the prior art, the non-oriented electrical steel for an electric vehicle drive motor and the manufacturing method thereof described in the present invention have the following advantages and beneficial effects:

In the non-oriented electrical steel for an electric vehicle drive motor described in the present invention, the inventors optimize the chemical element composition ratios and the related manufacturing process. The non-oriented electrical steel for an electric vehicle drive motor produced by the manufacturing method has the characteristics of high strength, low iron loss at high frequency, and high magnetic induction intensity, and further has the characteristic of small magnetic anisotropy.

The non-oriented electrical steel for an electric vehicle drive motor designed in the present invention has a yield strength of ≥440 MPa, an iron loss P_{10/600} of ≤30 W/kg, and a magnetic induction intensity B_{50M} of ≥1.60 T. The non-oriented electrical steel for an electric vehicle drive motor can be used to effectively prepare the drive motors of new energy vehicles, and effectively meet the market's requirements for high rotational speed, miniaturization, high torque, etc. of electric vehicle drive motors, which has good promotion prospects and application value.

### DETAILED DESCRIPTION

The non-oriented electrical steel for an electric vehicle drive motor and manufacturing method thereof described in the present invention will be further explained and illustrated with reference to the specific examples. However, the explanations and illustrations do not constitute an undue limitation on the technical solutions of the present invention.

### Examples 1-10 and Comparative Examples 1-6

Table 1 lists the mass percentage of each chemical element in the non-oriented electrical steels for electric vehicle drive motors of Examples 1-10 and the comparative steel plates of Comparative Examples 1-6.

TABLE 1
(wt %, the balance being Fe and inevitable impurities other than P, S, O, N)

| | Chemical elements | | | | | | | | | |
|---|---|---|---|---|---|---|---|---|---|---|
| | | | | | | | | | | Co, Ni, Sn, |
| Number | C | Si | Al | Mn | P | S | N | O | B | Sb, Cu, Cr |
| Example1 | 0.0029 | 3.05 | 0.55 | 2.21 | 0.008 | 0.0011 | 0.0015 | 0.0014 | — | |
| Example2 | 0.0012 | 3.24 | 0.75 | 0.82 | 0.006 | 0.0015 | 0.0008 | 0.0018 | — | |
| Example3 | 0.0014 | 3.32 | 2.5 | 0.55 | 0.012 | 0.0018 | 0.0012 | 0.0022 | — | Sn: 0.03 |
| Example4 | 0.0013 | 3.25 | 1.51 | 0.75 | 0.018 | 0.0017 | 0.0013 | 0.0014 | — | Sb: 0.02 |
| Example5 | 0.0016 | 3.41 | 1.05 | 1.55 | 0.024 | 0.0006 | 0.0014 | 0.0019 | — | Cr + Ni: 0.2 |
| Example6 | 0.0017 | 3.55 | 1.10 | 0.65 | 0.023 | 0.0009 | 0.0016 | 0.0009 | — | Cu: 1.0 |
| Example7 | 0.0015 | 3.69 | 0.72 | 0.58 | 0.014 | 0.0014 | 0.0012 | 0.0015 | — | Cu + Ni + Cr: 1.0 |
| Example8 | 0.0011 | 3.92 | 0.51 | 0.20 | 0.019 | 0.0013 | 0.0008 | 0.0008 | 0.008 | Co + Sn + |
| | | | | | | | | | | Cr + Sb: 0.85 |
| Example9 | 0.0013 | 4.15 | 0.20 | 0.15 | 0.017 | 0.0007 | 0.0019 | 0.0009 | 0.004 | Ni + Cr + Co: 4.0 |
| Example10 | 0.0010 | 4.50 | 0.16 | 0.20 | 0.008 | 0.0017 | 0.0021 | 0.0011 | 0.0005 | Co + Ni: 1.55 |
| Comparative | 0.0015 | 3.65 | 1.20 | 0.32 | 0.025 | 0.0021 | 0.0032 | 0.0021 | — | — |
| Example 1 | | | | | | | | | | |
| Comparative | 0.0018 | 3.25 | 0.55 | 2.41 | 0.016 | 0.0018 | 0.0022 | 0.0011 | — | — |
| Example 2 | | | | | | | | | | |
| Comparative | 0.0020 | 3.50 | 1.10 | 1.50 | 0.023 | 0.0017 | 0.0011 | 0.0016 | — | — |
| Example 3 | | | | | | | | | | |
| Comparative | 0.0020 | 2.65 | 1.50 | 1.21 | 0.023 | 0.0017 | 0.0011 | 0.0016 | — | — |
| Example 4 | | | | | | | | | | |
| Comparative | 0.0037 | 2.42 | 0.82 | 0.55 | 0.022 | 0.0033 | 0.0030 | 0.0024 | — | — |
| Example 5 | | | | | | | | | | |
| Comparative | 0.0021 | 2.80 | 0.004 | 0.5 | 0.029 | 0.0018 | 0.0025 | 0.0023 | — | — |
| Example 6 | | | | | | | | | | |

The non-oriented electrical steel for an electric vehicle drive motor of Examples 1-10 and the comparative steel plates of Comparative Examples 1-6 are prepared by the following steps:

(1) Preparing a casting slab according to the chemical composition ratios shown in Table 1.

(2) Hot rolling: hot rolling the obtained casting slab to obtain a hot-rolled plate with a thickness of 1.5 to 2.2 mm.

(3) Normalizing annealing: the obtained hot-rolled plate is transported to a horizontal continuous annealing furnace for normalizing annealing, the normalizing annealing temperature is controlled to 820° C.-950° C., the holding time of normalizing annealing is controlled to 90 s, and the unit tension F of a strip steel in an annealing furnace is controlled to satisfy the relational expression: 1.5≤F≤(3.8+0.3 d)/([Si]²×T), wherein d is a thickness of the hot-rolled plate in mm, T is a normalizing annealing temperature in ° C., [Si] is a content in percentage by mass of silicon element in the hot-rolled plate, and F is in N/mm².

(4) Cold rolling: performing a single cold rolling or a primary cold rolling+intermediate annealing+a secondary cold rolling to achieve the target thickness, to obtain a cold-rolled plate.

(5) Continuous annealing the cold-rolled plate in a continuous annealing furnace.

(6) Applying an insulating coating.

It should be noted that in the present invention, the chemical compositions and related process parameters of the non-oriented electrical steel for an electric vehicle drive motor of Examples 1-10 all meet the control requirements of the design specification according to the present invention; However, in Comparative Examples 1-6, although the comparative steels of Comparative Examples 1-6 are also prepared by the above-mentioned process steps, there are parameters that do not comply with the design of the present invention in their chemical element compositions and/or related process parameters.

Table 2 lists the specific process parameters in the above-mentioned manufacturing process and the final finished product thickness of the non-oriented electrical steels for electric vehicle drive motors of Examples 1-10 and the comparative steel plates of Comparative Examples 1-6.

TABLE 2

| | | Step (3) | | | |
|---|---|---|---|---|---|
| | | | Unit tension | | |
| | Step (2) | | F of a strip | | |
| | Hot-rolled | Normalizing | steel in an | | Finished |
| | plate | annealing | annealing | | product |
| | thickness | temperature T | furnace | Step (4) | thickness |
| Number | d (mm) | (° C.) | (N/mm²) | Cold rolling mode | (mm) |
| Example1 | 2.0 | 950 | 3.1 | single cold rolling | 0.30 |
| Example2 | 2.0 | 950 | 3.1 | single cold rolling | 0.30 |
| Example3 | 2.0 | 940 | 3.1 | single cold rolling | 0.30 |
| Example4 | 2.0 | 840 | 3.1 | single cold rolling | 0.27 |
| Example5 | 1.65 | 840 | 3.1 | double cold rolling | 0.27 |
| Example6 | 1.65 | 860 | 3 | double cold rolling | 0.25 |
| Example7 | 1.65 | 860 | 3 | double cold rolling | 0.25 |
| Example8 | 1.50 | 860 | 3 | double cold rolling | 0.20 |
| Example9 | 1.5 | 820 | 2.5 | double cold rolling | 0.20 |
| Example10 | 1.5 | 820 | 2.4 | double cold rolling | 0.20 |
| Comparative | 2.5 | 800 | 3.5 | single cold rolling | 0.3 |
| Example 1 | | | | | |
| Comparative | 2.2 | 920 | 5 | single cold rolling | 0.2 |
| Example 2 | | | | | |
| Comparative | 2.0 | 950 | 4 | single cold rolling | 0.25 |
| Example 3 | | | | | |
| Comparative | 2.0 | 950 | 3.5 | single cold rolling | 0.25 |
| Example 4 | | | | | |
| Comparative | 2.0 | 950 | 3.5 | single cold rolling | 0.2 |
| Example 5 | | | | | |
| Comparative | 2.0 | 940 | 3.5 | double cold rolling | 0.3 |
| Example 6 | | | | | |

The finished products of the non-oriented electrical steel for an electric vehicle drive motor of Examples 1-10 and the comparative steel plates of Comparative Examples 1-6 finally obtained were sampled respectively, and the mechanical performance, magnetic induction and iron loss of the steel plate samples of Examples 1-10 and Comparative Examples 1-6 are tested, to obtain the yield strength, magnetic induction intensity B_{50M} and iron loss P_{10/600}. The test results obtained are listed in Table 3 below.

The relevant performance test methods are as follows:

Statistics of grain size of steel plates: EBSD test is used to count each grain area and calculate the average grain size D and the grain size distribution standard deviation S.

Tensile test: The mechanical performance of the steel plates of each Example and Comparative Example is tested according to the national standard “GB/T 228.1-2010 Metallic Materials Tensile Test Part 1: Room Temperature Test Method”, to obtain the yield strength of the steel plates of each Example and Comparative Example.

Magnetic induction performance test: The magnetic induction performance test is performed using a square method according to the national standard “GB/T3655-2008 Method for Measuring the Magnetic Performance of an Electrical Steel Plate (Strip) Using an Epstein Square”, to obtain a magnetic induction intensity in a rolling direction B_{50L}, a magnetic induction intensity perpendicular to the rolling direction B_{50C}, and a minimum value of magnetic induction intensity of the steel plates at different angles from the rolling direction B_{50X} for each Example and Comparative Example when magnetized under a magnetic field of 5000 A/m.

At the same time, the magnetic induction intensity B_{50M} of the steel plate samples of Examples 1-10 and Comparative examples 1-6 was calculated by the formula B_{50M}=(B_{50L}+B_{50C}+2B_{50X})/4 based on the above obtained B_{50L}, B_{50C} and B_{50X}.

Iron loss performance test: The iron loss performance test is performed using a square method according to the standard “GB/T10129-2019 Method for Measuring the Medium-Frequency Magnetic Performance of an Electrical Steel Strip (Plate)”, to obtain the iron loss P_{10/600} of the steel plate samples of Examples 1-10 and Comparative Examples 1-6 at a magnetic flux density of 1.0 T and a frequency of 600 Hz.

Table 3 lists the test results of the non-oriented electrical steels for electric vehicle drive motors of Examples 1-10 and the comparative steel plates of Comparative Examples 1-6.

TABLE 3

| | Average | | Yield | Magnetic | |
|---|---|---|---|---|---|
| | grain | | strength | induction | Iron loss |
| Number | size (μm) | S/D | (MPa) | B_{50M} (T) | P_{10/600} (W/kg) |
| Example1 | 20 | 0.85 | 455 | 1.632 | 28.5 |
| Example2 | 35 | 0.84 | 450 | 1.641 | 27.2 |
| Example3 | 85 | 0.79 | 464 | 1.634 | 25.3 |
| Example4 | 105 | 0.98 | 448 | 1.637 | 28.2 |
| Example5 | 75 | 0.81 | 475 | 1.646 | 21.2 |
| Example6 | 89 | 0.80 | 492 | 1.662 | 20.5 |
| Example7 | 81 | 0.91 | 510 | 1.655 | 22.4 |
| Example8 | 95 | 0.99 | 523 | 1.653 | 19.1 |
| Example9 | 78 | 0.87 | 534 | 1.647 | 18.3 |
| Example10 | 54 | 0.82 | 565 | 1.634 | 17.5 |
| Comparative | 65 | 0.78 | 465 | 1.59 | 24.4 |
| Example 1 | | | | | |
| Comparative | 28 | 0.76 | 485 | 1.582 | 26.6 |
| Example 2 | | | | | |
| Comparative | 42 | 0.55 | 478 | 1.575 | 22.3 |
| Example 3 | | | | | |
| Comparative | 135 | 0.45 | 372 | 1.615 | 34.5 |
| Example 4 | | | | | |
| Comparative | 155 | 0.54 | 365 | 1.641 | 41.2 |
| Example 5 | | | | | |
| Comparative | 125 | 0.68 | 405 | 1.642 | 30.1 |
| Example 6 | | | | | |

With reference to the above Tables 1, 2 and 3, it can be seen that in the present invention, the non-oriented electrical steels for electric vehicle drive motors of Examples 1˜4 use a single cold rolling process, the control of chemical composition and the processes such as hot-rolled plate thickness, normalizing annealing temperature and the control of tension in furnace thereof are all within the range of the design of the present invention, and non-oriented silicon steels with low iron loss at high frequency, excellent magnetic anisotropy and high yield strength can be finally obtained.

The design of chemical composition and the process of the non-oriented electrical steel for an electric vehicle drive motor of Examples 5-10 also meet the requirements of the present invention. In Examples 5-10, the performance of the final steel plate can be further improved through microalloying and a double cold rolling, which is different from Examples 1-4.

As shown in Table 3 above, in the present invention, the non-oriented electrical steels for electric vehicle drive motors of Examples 1-10 have a yield strength of 448-565 MPa, a magnetic induction intensity B_{50M} of 1.632-1.662 T, and an iron loss P_{10/600} of 17.5-28.5 W/kg; and the overall performance of the non-oriented electrical steels for electric vehicle drive motors of Examples 1-10 is significantly better than that of the comparative steel plates of Comparative Examples 1-6. Since Comparative Examples 1-6 do not meet the conditions specified by the present technical solution, the implementation effects of Comparative Examples 1-6 are also inferior to those of the present invention.

The five comparative examples prepared herein can be further analyzed and explained with reference to the data listed in Tables 1, 2 and 3 above.

In Comparative Examples 1-3, although the chemical composition used in the steel is within the range designed by the present invention, the normalizing annealing temperature used is low (Comparative Example 1) or the tension F in furnace used is high (Comparative Examples 2 and Comparative Examples 3) during production, resulting in poor magnetic induction intensity B_{50M} of the final product.

In Comparative Examples 4-6, although the production processes adopted meet the requirements of the design of the present invention, there are parameters in the chemical composition that do not meet the requirements of the design of the present invention. The Si content or Al content in the steel is relatively low, which will result in a relatively high iron loss at high frequency and a yield strength lower than 440 Mpa in the finally prepared steel plates.

It should be noted that the prior art portion in the protection scope of the present invention is not limited to the embodiments given in the application document, and all prior art portions that do not contradict the solution of the present invention, including but not limited to the prior patent documents, prior publications, prior public use, etc., can all be included in the protection scope of the present invention.

Moreover, the combination of the technical features of the present invention is not limited to the combinations described in the claims or the specific embodiments of the present invention, and all the technical features of the present invention can be freely combined in any way unless contradicted with each other.

It should also be noted that the embodiments demonstrated above are only specific examples of the present invention. It is obvious that the present invention is not limited to the above embodiments, and various changes or modifications can be made. Such changes or modifications can be directly obtainable or easily conceivable for those skilled in the art from the disclosure in the present invention, and all of which fall within the scope of the present invention.

1. A non-oriented electrical steel for an electric vehicle drive motor, comprising, in addition to Fe and inevitable impurities, the following chemical elements in percentage by mass:
C≤0.003%, Si: 3.0-4.5%, Al: 0.15-2.5%, Mn: 0.15-2.5%;
wherein the non-oriented electrical steel for an electric vehicle drive motor has a magnetic induction intensity B_{50M} of ≥1.60 T, wherein B_{50M}=(B_{50L}+B_{50C}+2B_{50X})/4, wherein B_{50L} is a magnetic induction intensity in a rolling direction of the non-oriented electrical steel when magnetized under a magnetic field of 5000 A/m, B_{50C} is a magnetic induction intensity perpendicular to the rolling direction of the non-oriented electrical steel when magnetized under a magnetic field of 5000 A/m, B_{50X} is a minimum value of magnetic induction intensity of the non-oriented electrical steel at different angles from the rolling direction when magnetized under a magnetic field of 5000 A/m.

2. The non-oriented electrical steel for an electric vehicle drive motor according to claim 1, wherein the non-oriented electrical steel consists of the following chemical elements in percentage by mass:
C≤0.003%, Si: 3.0-4.5%, Al: 0.15-2.5%, Mn: 0.15-2.5%; the balance being Fe and inevitable impurities.

3. The non-oriented electrical steel for an electric vehicle drive motor according to claim 1, wherein C is of ≤0.002%.

4. The non-oriented electrical steel for an electric vehicle drive motor according to claim 1, wherein among the inevitable impurities, P≤0.03%, S≤0.003%, N≤0.005%, O≤0.0030%.

5. The non-oriented electrical steel for an electric vehicle drive motor according to claim 4, wherein among the inevitable impurities, P is of ≤0.02%, N is of ≤0.0035%.

6. The non-oriented electrical steel for an electric vehicle drive motor according to claim 1, wherein the non-oriented electrical steel further comprises B in an amount of 0.0005%-0.010% by mass.

7. The non-oriented electrical steel for an electric vehicle drive motor according to claim 1, wherein the non-oriented electrical steel further comprises at least one selected from Co, Ni, Sn, Sb, Cu, and Cr in a total amount of 0.020-4.0% by mass.

8. The non-oriented electrical steel for an electric vehicle drive motor according to claim 1, wherein the non-oriented electrical steel has a thickness of 0.1-0.3 mm.

9. The non-oriented electrical steel for an electric vehicle drive motor according to claim 1, wherein the non-oriented electrical steel has an average grain size D of 20-105 μm, and the average grain size D and a grain size distribution standard deviation S satisfy the following relational expression (1):
$$0.78 \leq S / D < 1. . \qquad ( 1 )$$

10. The non-oriented electrical steel for an electric vehicle drive motor according to claim 1, wherein the non-oriented electrical steel has a yield strength of ≥440 MPa, and an iron loss P_{10/600} of ≤30 W/kg.

11. A manufacturing method for the non-oriented electrical steel for an electric vehicle drive motor according to claim 1, wherein the manufacturing method comprises the following steps:
(1) preparing a casted slab;
(2) hot rolling the casted slab to obtain a hot-rolled plate with a thickness of 1.5 to 2.2 mm;
(3) normalizing annealing the hot-rolled plate at a normalizing annealing temperature of 820° C. to 950° C.;
(4) cold rolling to obtain a cold-rolled plate;
(5) continuous annealing the cold-rolled plate in a continuous annealing furnace;
(6) applying an insulating coating.

12. The manufacturing method according to claim 11, wherein in step (3), a horizontal continuous annealing furnace is used for normalizing annealing.

13. The manufacturing method according to claim 11, wherein in step (3), a unit tension F of a strip steel in an annealing furnace for normalizing annealing is controlled to satisfy the relational expression (2): 1.5≤F≤(3.8+0.3 d)/([Si]²×T), wherein d is a thickness of the hot-rolled plate in mm, T is a normalizing annealing temperature in ° C., [Si] is a percentage by mass of silicon element in the hot-rolled plate, and F is in N/mm².

14. The manufacturing method according to claim 11, wherein in step (4), the cold rolling is a single cold rolling, or a double cold rolling including an intermediate annealing.

15. The non-oriented electrical steel for an electric vehicle drive motor according to claim 2, wherein C is of ≤0.002%.

16. The non-oriented electrical steel for an electric vehicle drive motor according to claim 2, wherein among the inevitable impurities, P≤0.03%, S≤0.003%, N≤0.005%, O≤0.0030%.

17. The non-oriented electrical steel for an electric vehicle drive motor according to claim 16, wherein among the inevitable impurities, P is of ≤0.02%, N is of ≤0.0035%.

18. The non-oriented electrical steel for an electric vehicle drive motor according to claim 2, wherein the non-oriented electrical steel further comprises B in an amount of 0.0005%-0.010% by mass.

19. The non-oriented electrical steel for an electric vehicle drive motor according to claim 2, wherein the non-oriented electrical steel further comprises at least one selected from Co, Ni, Sn, Sb, Cu, and Cr in a total amount of 0.020-4.0% by mass.

20. The non-oriented electrical steel for an electric vehicle drive motor according to claim 2, wherein the non-oriented electrical steel has a thickness of 0.1-0.3 mm.
